(19) United States
(12) Patent Application Publication
(10) Pub. No.: US 2008/0187626 A1
(43) Pub. Date: Aug. 7, 2008

(54) Method for Producing an Edible Concentrated Proteinic Hydrolysate, Especially a Soup Concentrate and Uses Thereof

(76) Inventor: Stig Voldbjerg Sorensen, Lyngby (DK)

Correspondence Address: WINSTON & STRAWN LLP;PATENT DEPARTMENT, 1700 K STREET, N.W., WASHINGTON, DC, 20006, US

(21) Appl. No.: 11/909,938

(22) PCT Filed: Mar. 28, 2006
(86) PCT No.: PCT/IB2006/050939

§ 371 Date: Sep. 27, 2007

(30) Foreign Application Priority Data
Mar. 30, 2005 (DK) PA 2005 00439

(51) Int. Cl. A23J 3/34; A23L 1/305; A23L 1/40; A23J 3/14; A23J 3/04

(52) U.S. Cl. 426/52; 426/7; 426/56; 426/589; 426/506

(57) ABSTRACT

An edible, concentrated, proteinic hydrolysate is made by means of a method that includes enzymatically hydrolysing the proteins in an aqueous reaction mixture of a proteinic raw material and at least one enzyme, and deactivating the at least one enzyme. The volume of the obtained, aqueous hydrolysate is reduced by boiling down the hydrolysate to at least half volume to obtain a hydrolysate concentrate, to which salt is added until the saturation point of the hydrolysate concentrate has been essentially reached. The salt saturated soup concentrate does not need further preservation and has a long storage life at room temperature. The soup concentrate is easily diluted to a nutrient-rich, salt-tasted soup ready for being eaten.

The present invention relates to a method for producing a soup concentrate and of the kind that comprises enzymatically hydrolyzing the proteins in an aqueous reaction mixture of a proteinic raw material and at least one enzyme and deactivating the at least one enzyme.

The invention furthermore relates to a soup concentrate produced by means of the method and the use of the soup concentrate.

In the daily household, soup is made by cooking meat or large quantities of meaty bones in water together with vegetables and spices for a long time. Such a soup typically has a low solids content of 1-2 w % protein. A large part of this protein is collagen, the network structure of which is unfolded during the slow heat-up and allows the proteolytic enzymes contained in the meat to better perform their action so that, when the soup reaches a temperature of or above 60-65° C., most of the collagen will be converted into readily soluble gelatin. This soup is flavourfull and is made in accordance with national traditions and customary practice but only in small quantities.

This way of producing soup is however inexpedient for producing soup and soup concentrates on an industrial scale. Partly, meat is an expensive raw material, and the process takes a long time.

Plants that utilize by-products from the food processing industry for producing, among other things, aroma and soups is known from the inventor's own International Patent Applications Nos. PCT/DK2003/000869 and PCT/DK2003/000870 and from the Danish Patent No. 175501.

In these known plants the protein content of the by-products are hydrolysed in order to produce amino acids and peptides that can be used as e.g. dietary supplements or aromatics after further processing. To obtain the greatest possible yield, a high degree of hydrolysis is used, that is as many peptide bonds as possible must be hydrolysed. However, the hydrolysate obtained by enzymatic hydrolysis often has an unpleasant acrid after-taste. This after-taste is not a problem when the hydrolysate is produced in order to be purified and fractionated to separate components, for example single amino acids for use as nutritional supplement.

Due to the after-taste, hydrolysate soup has been regarded unsuitable for direct consumption up to now, the organoleptic properties are unsatisfactory, and the very varying taste makes the soup unsuitable as consumable finished product. Soups made by enzymatic hydrolysis of a raw material furthermore have a low protein content of less than 1% and therefore a low nutritional value.

Semi-finished soup products and finished soup products for consumption comprise for instance soup pastes, canned soup, bouillon cubes, and powdered soups and sauces. These semi-finished products can e.g. be produced on basis of the hydrolysate made by using the above known plants. However, the unpleasantly tasting substances must be removed from the hydrolysate before the soup is suited for consumption. Furthermore, it may be necessary to add flavour-enhancing substances and preservatives. Despite this, the taste of e.g. powdered soups is far from the taste of the above home-cooked soup.

In a first aspect according to the present invention a concentrated hydrolysate is provided that is suited for consumption.

In a second aspect according to the present invention a concentrated hydrolysate is provided for producing a soup or a sauce without unpleasant smell and taste and discoloration.

In a third aspect according to the present invention a liquid soup concentrate having a long storage life is provided.

In a fourth aspect according to the present invention a soup concentrate without additives from the E-number list is provided.

In a fifth aspect according to the present invention a soup concentrate is provided, by means of which it is possible to produce a soup which is ready for being eaten and which tastes as soup made in a conventional way by cooking meat, herbs and water.

The novel and unique feature according to the invention, whereby this is achieved, is the fact that the volume of the obtained, aqueous hydrolysate is reduced by boiling down the hydrolysate to at least half volume to obtain a hydrolysate concentrate and that salt is added to the hydrolysate concentrate until the saturation point of the hydrolysate concentrate has been essentially reached.

The enzymatically made, non-concentrated hydrolysate typically has a solids content of 6-9 w % based on the weight of the hydrolysate and raw material and therefore has a high nutritional value that advantageously can be used for consumption, an adequate storage life of said hydrolysate being obtained without adding to the cost of the product.

Because of the taste, large amount of salt has hitherto not been used as a storage life extending and preserving means for hydrolysate concentrates for consumption as persons skilled in the art hitherto have not been able to find use for such a salty and inedible protein concentrate.

A salt saturated solution however has a very long storage life at e.g. room temperature as the high salt content provides unfavourable growth conditions for microorganisms. The salt saturated hydrolysate concentrate does not need any further preservation to maintain a storage life of minimum 6 months, and the salt saturation therefore replaces usual, costly preservation methods, such as freezing, lyophilization, pasteurisation, ultrahigh temperature treatment and the like.

In an advantageous embodiment of the present invention, the proteinic raw material can be hydrolized until a maximum of 13% of the peptide bonds of the protein have been hydrolized.

Such a degree of hydrolysis of peptide bonds has surprisingly shown to result in the hydrolysate keeping and promoting the specific taste from the raw material for example chicken or beef.

If the degree of hydrolysis is increased to much more than 13%, the hydrolysate will loose its raw material specific taste, and whatever the taste of the raw material, all hydrolysates will end up tasting the same. At the same time a gradually acrid taste is developed. The type of acrid taste and the severity of acridity have shown to be dependent on the chosen used enzyme.

Preferably the at least one enzyme comprises at least one protease, preferably a protease produced by one or more Bacillus species.

An especially preferred protease is a collagen specific enzyme as application of such enzymes has shown to reduce development of the acrid taste.

An example of enzymes suited for use in the present invention is e.g. Neutrase® that is a neutral bacterial protease produced by a chosen strain of Bacillus amyloliquefaciens. The optimum stability and activity of Neutrase® depends on the protein concentration and types of protein. Neutrase® which has a preferred reaction pH in the pH range of 5.5-7.5 for a preferred reaction temperature from 45-55° C., can preferably be used to improve the nutritional value and taste properties of the proteins. Novozymes A/S, Krogshøjvej 36, 2880 Bagsværd, Denmark produces different types of applicable Neutrase®.

The preferred proteinic raw materials are either animal or vegetable ones. The raw material meaty by-products from the food processing industry is especially preferred, especially from processing food products of cattle, pig, fish, or poultry.

For the preferred soup concentrate less than or 10 wt % of the peptide bonds in the raw material protein hydrolysed, the concentration of protein being equal to or larger than 50 wt % based on the weight of the boiled down hydrolysate, and the concentration of salt in the soup concentrate is equal to or larger than 10 wt % based on the weight of the boiled down hydrolysate.

This soup concentrate can be stored for a long time at room temperature and does not require further addition of preservatives from the E-number list (EU list of approved additives for food products; EUFIC, 19, rue Guimard, 1040 Brussels, BELGIUM).

An especially tasty soup ready for being eaten is made by heating one part of the above salt saturated soup concentrate with 9-10 parts of water.

Such a diluted soup concentrate is a nutritive soup ready for being eaten and having a salt content corresponding to the salt content that a traditionally cooked meat or vegetable soup need to give a good taste experience.

Within the scope of the invention both meat and vegetable soups can be made, just as the dilution of the salt saturated protein concentrate can be more or less dependent on taste and demand.

### EXAMPLE

### Production of a Chicken Soup Concentrate

Chicken bones from deboning of chicken are used as meaty raw material. The bones are broken into pieces of about 1 by 2 cm and transferred to a plant according to International Patent Application PCT/DK2004/000869 (not published). Water is added at a 1:1 ratio. This reaction mixture is stirred during heating to 55° C., after which 1 g Neutrase® 1.5MG per kilo raw material. The hydrolysis is allowed to proceed for 30 minutes. The reaction mixture is heated to 95° C. for 25 minutes during stirring to inactivate the enzyme. Stirring is discontinued and the hydrolysate is drawn and transferred to a buffer tank. The hydrolysate is separated in a tricanter into three fractions: (1) fat and (2) insoluble components and (3) pure hydrolysate with soluble proteins. The pure hydrolysate from fraction (3) is boiled down and concentrated to 50% protein solids based on the total weight of the boiled down hydrolysate, and the concentrate is saturated with salt giving a salt content of 11% based on the total weight of the salted concentrate.

The salt saturated concentrate has a salt content in water phase of about 20% and therefore has a very long storage life as finished product.

The obtained hydrolysate is thus concentrated from 6-9 wt % protein to 50 wt % based on the weight of the concentrated hydrolysate. By the subsequent addition of salt, a product is obtained that is very non-perishable at room temperature and that upon subsequent addition of 10 parts of water to one part of salted concentrate gives a salted soup having an desirable and natural soup taste originating from the about 5 wt % dry solids in the finished soup.

1.-9. (canceled)

10. A method for producing a concentrated, proteinic hydrolysate which comprises:
enzymatically hydrolysing proteins in an aqueous reaction mixture of a proteinic raw material and at least one enzyme, and
deactivating the at least one enzyme to obtain an aqueous hydrolysate,
reducing the hydrolysate by boiling it to at least half volume to obtain a hydrolysate concentrate, and
adding a salt to the hydrolysate concentrate until the saturation point of the hydrolysate concentrate is essentially reached.

11. The method according to claim 10, wherein the hydrolysate concentrate is provided in the form of a soup concentrate

12. The method according to claim 1, wherein the proteinic raw material is hydrolysed until a maximum of 13% of the peptide bonds of the protein has been hydrolysed.

13. The method according to claim 10, wherein the at least one enzyme comprises at least one protease.

14. The method according to claim 10, wherein the at least one enzyme comprises at least one protease produced by one or more Bacillus species.

15. The method according to claim 13, wherein the at least one protease is a collagen specific enzyme.

16. The method according to claim 10, wherein the proteinic raw material is of animal origin.

17. The method according to claim 1, wherein the proteinic raw material is of vegetable origin.

18. A soup concentrate produced according to the method of claim 12, wherein
less than or 10% of the peptide bonds in the protein of the raw material is hydrolysed,
the protein in the concentrate has a concentration that is equal to or larger than 50 wt % based on the weight of the boiled down hydrolysate, and
the in the concentrate has a concentration that is equal to or larger than 10 wt % based on the weight of the boiled down hydrolysate.

19. The soup concentrate according to claim 18, which does not contain E-number list preservatives.

20. A method of producing a soup that is ready to be eaten, wherein one part of the soup concentrate according to claim 18 is heated with nine parts of water.
